(19) United States
(12) Patent Application Publication
(10) Pub. No.: US 2014/0040373 A1
(43) Pub. Date: Feb. 6, 2014

(54) INFORMATION PROCESSING DEVICE, INFORMATION PROCESSING METHOD, AND INFORMATION PROCESSING SYSTEM

(71) Applicant: Sony Corporation, Tokyo (JP)

(72) Inventor: Shingo TAKAMATSU, Tokyo (JP)

(73) Assignee: Sony Corporation, Tokyo (JP)

(21) Appl. No.: 13/949,423

(22) Filed: Jul. 24, 2013

(30) Foreign Application Priority Data
Jul. 31, 2012 (JP) 2012169499

(51) Int. Cl. H04L 29/08

(52) U.S. Cl. CPC H04L 67/02
USPC 709/204

(57) ABSTRACT

An information processing device includes a collection section that collects log data of a plurality of users from a plurality of services, a publishing level setting section that is possible to set a publishing level of the collected log data to each service for each user, and a providing control section that controls provision of the collected log data to the plurality of services based on the publishing level that is set.

### BACKGROUND

The present disclosure relates to an information processing device, an information processing method, and an information processing system, and more specifically to an information processing device, an information processing method, and an information processing system that allow sharing log data among a plurality of services.

In recent years, with the spread of social services, it is commonly carried out to browse information that is transmitted from another user and to share information with another user. With this, techniques for flexibly setting a range of publishing information in transmitting the information are proposed (for example, refer to Japanese Unexamined Patent Application Publication No. 2008-262280).

In addition, many users utilize, not limited to social services, a plurality of services (network services) that are provided via networks, such as the internet, like electronic commerce (e-commerce) and personalized services.

### SUMMARY

However, in the past, each service has individually managed respective user log data and convenience of a user that utilizes a plurality of services has not been considered in particular. Accordingly, for example, such a situation in which goods purchased by a user utilizing a certain service were recommended by another service used to occur.

It is desirable to improve convenience when a user utilizes a plurality of services.

An information processing device according to an embodiment of the present technology includes: a collection section that collects log data of a plurality of users from a plurality of services; a publishing level setting section that is possible to set a publishing level of the collected log data to each service for each user; and a providing control section that controls provision of the collected log data to the plurality of services based on the publishing level that is set.

The publishing level setting section is possible to further set the publishing level for each service at a publishing destination.

The publishing level setting section is possible to further set the publishing level based on relationship between a user to publish the log data and a user to browse it.

The publishing level setting section is possible to further set the publishing level based on whether or not the service at a publishing destination is a service that a user to publish the log data utilizes.

The publishing level setting section is possible to further set the publishing level for each type of log data.

The publishing level setting section is possible to further set she publishing level based on one or more combinations of the service at a publishing destination, relationship between a user to publish the log data and a user to browse it, whether or not the service at a publishing destination is a service that the user to publish the log data utilizes, and a type of log data.

The providing control section is possible to control a range and a mode of providing the collected log data to each service based on the publishing level.

An information processing method according to an embodiment of the present technology, which is carried out by an information processing device, includes: collecting log data of a plurality of users from a plurality of services; publishing level setting possible to set a publishing level of the collected log data to each service for each user; and controlling provision of the collected log data to the plurality of services based on the publishing level that is set.

An information processing system according to another embodiment of the present technology includes a first server, a plurality of second servers that provide a predetermined service, and a plurality of clients that utilize the service that is provided by the second servers. The first server has: a collection section that collects log data of a plurality of users from a plurality of services; a publishing level setting section that is possible to set a publishing level of the collected log data to each service for each user; and a providing control section that controls provision of the collected log data to the plurality of services based on the publishing level that is set.

According to the embodiment or the other embodiment of the present technology, it is possible to share log data among a plurality of services. In addition, according to the embodiment or the other embodiment of the present technology, the convenience when a user utilizes a plurality of services is improved.

### BRIEF DESCRIPTION OF THE DRAWINGS

FIG. 1 illustrates an outline or a log sharing service by an embodiment of the present technology;

FIG. 2 is a block diagram illustrating an embodiment of an information processing system to which an embodiment of the present technology is applied;

FIG. 3 is a block diagram illustrating a configuration example of a function of a log data bank;

FIG. 4 illustrates a first specific example of services and users;

FIG. 5 is a flowchart to illustrate log data collection process;

FIG. 6 is a flowchart to illustrate privacy level setting process;

FIG. 7 illustrates contents of privacy level settings;

FIG. 8 illustrates an example of a movie replay log and a movie replay frequency log;

FIG. 9 is a flowchart to illustrate log data providing process;

FIG. 10 is a flowchart to illustrate a specific example of the log data providing process;

FIG. 11 illustrates a second specific example of services and users; and

FIG. 12 is a block diagram illustrating a configuration example of a computer.

### DETAILED DESCRIPTION OF EMBODIMENTS

Descriptions are given below to a mode for carrying out an embodiment of the present technology (hereinafter, referred to as an embodiment). The descriptions are provided in the following order:

1. Outline of Mode of Utilizing an Embodiment of the Present Technology;

2. Embodiment; and

3. Modifications.

### 1. Outline of Mode of Utilizing an Embodiment of the Present Technology

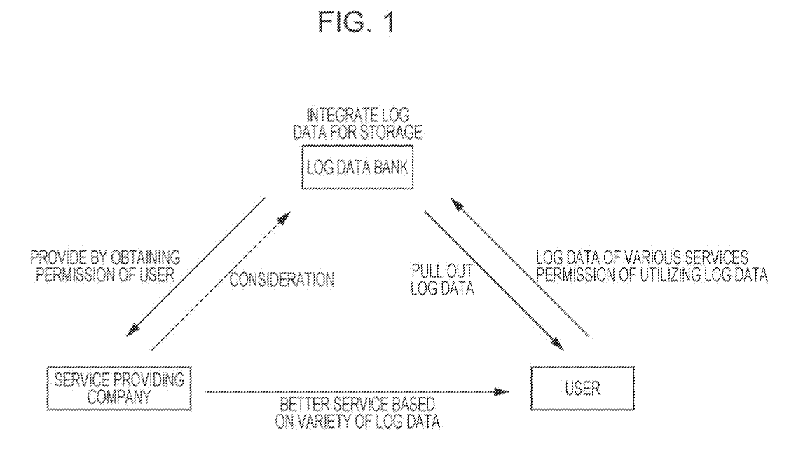

Firstly, with reference to FIG. 1, an example of a log sharing service by an embodiment of the present technology is described briefly.

The log sharing service is a service that is provided by a log data bank, collects log data generated by utilizing a service that is provided by a service providing company, and shares the log data among a plurality of service providing companies.

The type of service is not limited in particular as long as it is a network service provided via a network, such as the internet. For example, there are assumptions of social services, electronic commerce, personalized services, and the like. In addition, such services also includes those utilized by a service providing company not only those utilized by a user.

The type of log data utilized in the log sharing service is not limited in particular as long as it is generated by utilizing a service. For example, there are assumptions of a log of utilizing a service, a log of purchasing goods and the like, a log of utilizing a content, friend information among users in a social service and the like, various types of information (images, audio, comments, location information, and the like) that is transmitted from a user, and the like. Still in addition, not only log data generated by utilization of a service by a user, log data generated by utilization of a service, provided by a service providing company, by another service providing company is also included.

The log data bank collects log data generated by utilization of a service by a user or a service providing company from a service providing company that provides the service for integration and storage.

Each service providing company makes a contract with a company that operates the log data bank to utilize a log sharing service. The service providing company also pays a consideration to the company that operates the log data bank as desired.

Each service providing company also provides log data generated by utilization of a service that it provides by a user or another service providing company to the log data bank. On the other hand, each service providing company is possible to utilize log data stored in the log data bank regardless of whether or not the data relates to a service of the own company.

This enables each service providing company to utilize log data of not only a service of the own company but also of services of other companies, and thus it is possible to provide a better service to a user or another service providing company based on a variety of log data. Then, a user or another service providing company can benefit from the service.

For example, a service providing company carrying out electronic commerce can carry out more accurate marketing researches by utilizing log data of a plurality of services, and thus it becomes possible to provide services and goods conforming more to user demands.

In addition, in a case of launching a new service, for example, a service providing company can quickly put the service on track using a variety of user logs. For example, in newly launched electronic commerce, it becomes possible to recommend goods that suit each user's taste from the initial period of the start. In addition, for example, in a case of launching a new social networking service (SNS), it is possible to more quickly put the service on track for many users from the initial period of the start by taking over log data of another SNS and the like.

Further, it becomes possible that a service providing company verifies, for example, the viability, potential, or the like of a new idea or plan without actually performing the idea or plan based on the variety of log data.

In addition, in a case of utilizing a personalized service, for example, a user can receive a more personally specialized service based on the variety of items and types of log data, and thus the convenience is improved.

Further, a user does not have to provide similar log data to another service as long as he or she provides log data to one service. Accordingly, for example, acquisition of location information in a global positioning system (GPS) from a plurality of services at the same time enables to avoid such a situation in which process in a terminal, such as a smartphone and a mobile phone that belongs to a user, becomes heavy.

Moreover, for example, in a case that a service similar to a service in use is newly started, a user can easily switch to the new service by sharing log data among the new service and the service in the past.

Furthermore, in a case that there are a plurality of similar SNSs, for example, a user can choose a service that he or she likes in accordance with the preferences, such as a user interface (UI), and can also interact with users of other services.

A user can also pull out log data of each service stored in the log data bank for utilization.

Since log data contains user privacy information, unconditional publishing of log data of a certain service to another service may create a risk of a problem, such as privacy leakage, to occur.

With that, as described later, in a log sharing service to which an embodiment of the present technology is applied, a user is enabled to set a level of permitting utilization of log data, that is, a level of publishing log data. Then, with permission of the user, the log data bank provides log data of each use to the respective service providing companies.

### 2. Embodiment

### [Configuration Example of Information Processing System]

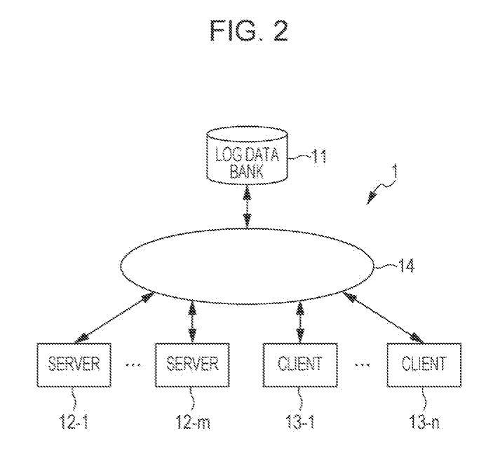

FIG. 2 is a block diagram illustrating an embodiment of an information processing system to which an embodiment of the present technology is applied.

An information processing system 1 is configured to include a log data bank 11, servers 12-1 through 12-m, and clients 13-1 through 13-n. The log data bank 11, the servers 12-1 through 12-m, and the clients 13-1 through 13-n are connected with each other via a network 14.

In the descriptions below, in a case that the servers 12-1 through 12-m do not have to be distinguished individually, they are referred to simply as servers 12. In addition, in the descriptions below, in a case that the clients 13-1 through 13-n do not have to be distinguished individually, they are referred to simply as clients 13.

The log data bank 11 provides the log sharing service described above to the servers 12 and the clients 13.

The servers 12 are owned by the service providing company described, above and provide a predetermined service to a user or another service providing company. It is possible to provide a plurality of services by one server 12 and also to provide one service by a plurality of servers 12.

The clients 13 are configured with a device capable of utilizing a log sharing service or a service that is provided by the server 12, such as a personal computer, a personal digital assistance, a mobile phone, and a smartphone, for example.

The clients 13 do not have to be capable of utilizing all services that are provided by the servers 12 in all cases.

### [Configuration Example of Log Data Bank 11]

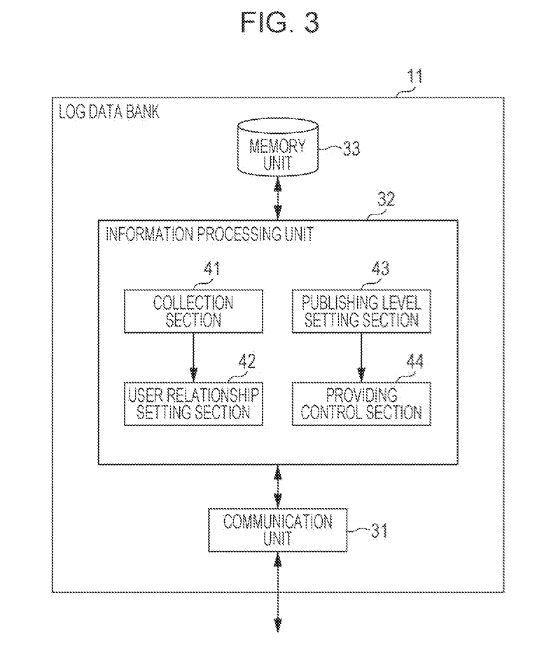

FIG. 3 is a block diagram illustrating a configuration example of a function of a log data bank 11.

The log data bank 11 is configured to include a communication unit 31, an information processing unit 32, and a memory unit 33. Each of she communication unit 31 and the information processing unit 32 is capable of accessing with each other. Each section of the information processing unit 32 is capable of accessing the memory unit 33.

The communication unit 31 carries out communication with each server 12 and each client 13 via the network 14, and carries out sending and receiving of various types of information, directions, and the like related to the log sharing service. In the sent and received information, log data of each service is included.

The information processing unit 32 carries out various types of processing related to the log sharing service. The information processing unit 32 is configured to include a collection section 41, a user relationship setting section 42, a publishing level setting section 43, and a providing control section 44.

The collection section 41 collects log data of each service that is provided by each server 12 from each server 12 via the network 14 and the communication unit 31. The collection section 41 integrates the log data collected from each server 12 into a predetermined format as desired to be memorized in the memory unit 33. In addition, the collection section 41 supplies friend information in each service included in the log data to the user relationship setting section 42.

Here, friend information is information indicating whether or not a certain user registers as a friend for another user. A friend indicates another user that a certain user is linked bidirectionally on a service, that is, another user to whom a certain user has a bidirectional connection on a service.

The user relationship setting section 42 updates user relationship information indicating friendship among users based on friend information in each service. The user relationship setting section 42 causes the updated user relationship information to be memorized in the memory unit 33.

The publishing level setting section 43 receives setting information for a privacy level that is set by each user in each client 13 via the network 14 and the communication unit 31. The publishing level setting section 43 updates privacy level registration information in which a privacy level of each user is registered based on the setting information thus received to be memorized in the memory unit 33.

In addition, the publishing level setting section 43 sets a publishing level of the log data of each user for each service based on the privacy level registration information and the user relationship information that are memorized in the memory unit 33. The publishing level setting section 43 notifies the providing control section 44 of the publishing level thus set.

Here, the privacy level is set by each user and is used for setting a publishing level of the log data of each user. The publishing level defines a range and a mode of publishing of log data.

The providing control section 44 provides the log data that is memorized in the memory unit 33 for each server 12 or each client 13 via the communication unit 31 and the network 14. In addition, the providing control section 44 controls the range and the mode to provide log data for each service based on the publishing level that is set by the publishing level setting section 43.

### [Process in Log Data Bank 11]

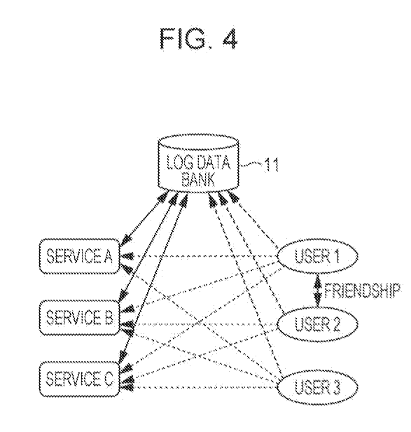

Next, with reference to FIGS. 4 through 10, descriptions are given to processing in the information processing system 1.

For plain explanation, as illustrated in FIG. 4, descriptions are given below to a case that services A through C are provided by each server 12 and users 1 through 3 utilize the information processing system 1. Details of the services A through C and the users 1 through 3 are as follows.

The service A is an SNS to share a movie replay log among users and has the following functions.

To display a log of movies that a user has replayed (hereinafter, referred to as a past log)
To display a log of movies that a user has replayed in the last week (hereinafter, referred to as a recent log). It is to be noted that only friends can browse.

To display a user name

User search

Friend registration among users

To write and display a text message

The service A uses three types of log data, which are a movie replay log, a text message log, and friend information.

The service B is an SNS to share a log of replaying a piece of music among users and has the following functions.

To display a log of a piece of music that a user has replayed (hereinafter, referred to as a past log)

To display a log of a piece of music that a user has replayed in the last week (hereinafter, referred to as a recent log). It is to be noted that only friends can browse.

To display a user name

User search

Friend registration among users

To write and display a text message.

The service B uses three types of log data, which are a music replay log, a text message log, and friend information.

The service C is a service or streaming delivery of movies and music. As each user replays a movie, the service C records a movie replay log, which is log data thereof. As each user replays a piece of music, the service C records a music replay log, which is log data thereof.

The user 1 utilizes the services A through C and is a friend of the user 2.

The user 2 utilizes the services A and C and is a friend of the user 1. The user 2 does not utilize the service B.

The user 3 utilizes the services A through C and is not a friend of the users 1 and 2.

A service utilized by a user indicates a service that recorded such that the user carries out utilization registration and makes a utilization contract and the like and log data generated by the utilization of the user is identified as the data of the user different from another user.

In the descriptions below, a case that the server 12 that provides the service A, for example, carries out some processing, may also be expressed simply by omitting the description of the server 12 in such a manner that the service A carries out processing.

### (Log Data Collection Process)

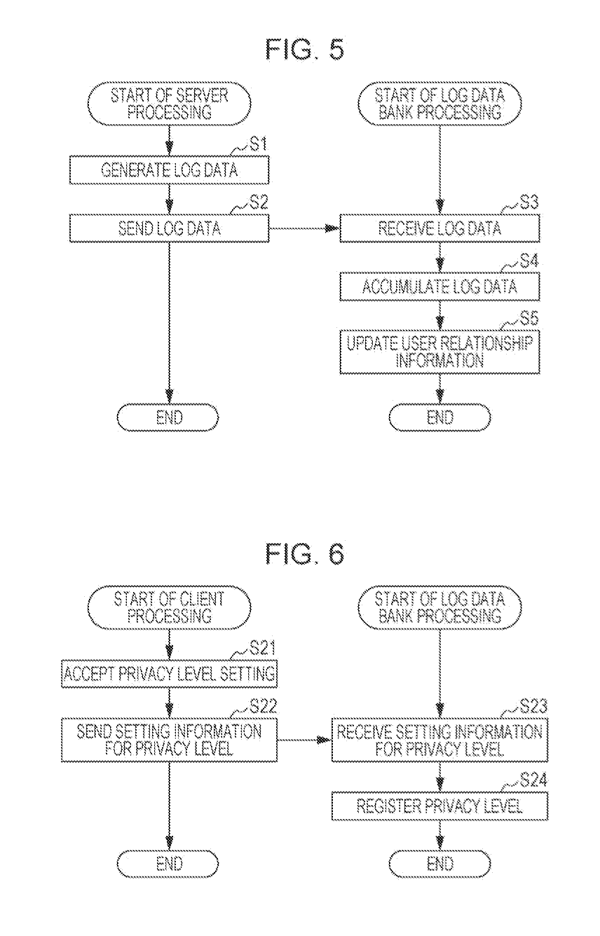

Next, with reference to the flowchart in FIG. 5, descriptions are given to log data collection process performed by the information processing system 1. Such process starts when a user utilizes a service that is provided by the server 12 using the client 13.

In step S1, the server 12 generates log data.

For example, in a case that the user 1 or user 3 generates a text message utilizing the service A, the service A generates a text message log containing the text message. Similarly, for example, in a case that the users 1 through 3 generate text messages utilizing the service B, the service B generates a text message log containing the text messages.

In addition, for example, in a case that she user 1 or the user 3 registers as a friend for another user utilizing the service A, the service A generates friend information containing contents of the friend registration. Similarly, in a case that the users 1 through 3 register another user as a friend utilizing the service B, for example, the service B generates friend information containing contents of the friend registration.

Further, in a case that the users 1 through 3 replay a movie or a piece of music utilizing the service C, for example, the service C generates a movie replay log or a music replay log indicating the replay history.

In step S2, the server 12 sends the log data thus generated so the log data bank 11 via the network 14.

It is possible to optionally set timing that the server 12 sends the log data to the log data bank 11. For example, the server 12 may send soon after the provided service is utilized and the log data is generated and may also temporarily accumulate the log data thus generated to be sent periodically or every time a certain amount of log data is accumulated.

In step S3, the collection section 41 of the log data bank 11 receives the log data sent from the server 12 via the communication unit 31.

In step S4, the collection section 41 accumulates the log data. Specifically, the collection section 41 converts data except the friend information in the log data thus received to a predetermined format as desired. This format offsets the difference in log data formats between the services for standardization. Then, the collection section 41 accumulates the log data in the memory unit 33.

It does not have to convert the formats in all cases, and the log data thus received may also be accumulated directly in the memory unit 33.

In step S5, the user relationship setting section 42 updates the user relationship information. Specifically, in a case that there is friend information in the log data thus received, the collection section 41 supplies the friend information to the user relationship setting section 42. The user relationship setting section 42 updates the user relationship information that is memorized in the memory unit 33 based on the friend information thus acquired. The user relationship information is a summary of the friendship among users in each service.

After that, the log collection process terminates.

Then, by repeating the log collection process, the log data generated by utilization of each service is accumulated in the memory unit 33 of the log data bank 11. In addition, the user relationship information indicating the friendship between each user is updated.

### (Privacy Level Setting Process)

Next, with reference to the flowchart in FIG. 6, descriptions are given to privacy level setting process performed by the information processing system 1. The process starts when, for example, a user carries out an operation to set a privacy level in the client 13.

In step S21, the client 13 accepts setting of a privacy level. Specifically, for example, the client 13 displays a screen to set a privacy level, and the user sets the privacy level in accordance with the setting screen. The client 13 acquires the setting information for the privacy level.

In step S22, the client 13 sends the setting information for the privacy level to the log data bank 11 via the network 14.

In step S23, the publishing level setting section 43 of the log data bank 11 receives the setting information for the privacy level that is sent from the client 13 via the communication unit 31.

In step S24, the publishing level setting section 43 registers the privacy level of a user subjected to setting in the privacy level registration information that is memorized in the memory unit 33 based on the setting information thus received.

After that, the privacy level setting process terminates.

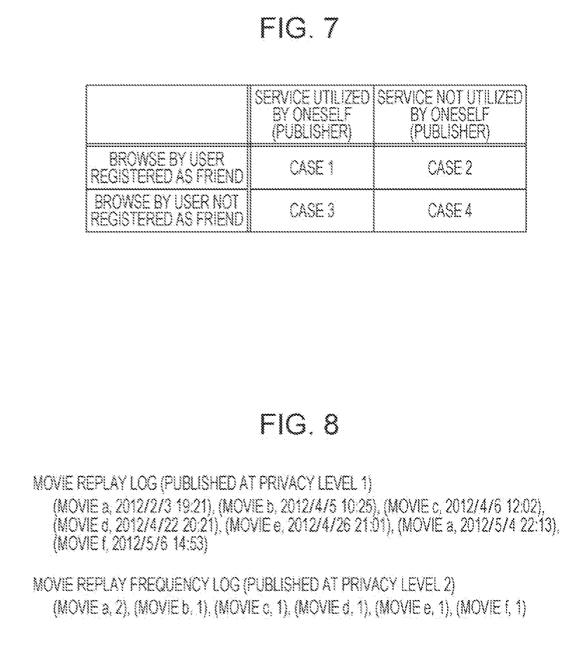

Here, with reference to FIGS. 7 and 8, descriptions are given to an example of contents of privacy level settings in the specific example of FIG. 4.

For example, each user can set two types of privacy levels of a privacy level for the movie replay log, the music replay log, and the text message (hereinafter, referred to as a first privacy level) and a privacy level for the friend information (hereinafter, referred to as a second privacy level).

The first privacy level can also be set individually for cases 1 through 4 illustrated in FIG. 7. In the cases 1 through 4, oneself (publisher) is a user that publishes the log data to be browsed, and is the user that sets the privacy level in this process.

The case 1 is a case that a user registered as a friend (browser) browses the log data from a service that the publisher utilizes. For example, this is a case that the user 1 (browser), who is a friend of the user 2 (publisher), browses the log data of the user 2 from the service B that the user 2 utilizes.

The case 2 is a case that a user registered as a friend (browser) browses the log data from a service that the publisher does not utilize. For example, this is a case that the user 1 (browser), who is a friend of the user 2 (publisher), browses the log data of the user 2 from the service A chat the user 2 does not utilize.

The case 3 is a case that a use that is not registered as a friend (browser) browses the log data from a service that the publisher utilizes. For example, this is a case that the user 3 (browser), who is not a friend of the user 2 (publisher), browses the log data of the user 2 from the service B that the user 2 utilizes.

The case 4 is a case that a user that is not registered as a friend (browser) browses the log data from a service that the publisher does not utilize. For example, this is a case that the user 3 (browser), who is not a friend of the user 2 (publisher), browses the log data of the user 2 from the service A that the user 2 does not utilize.

In addition, the first privacy level can be set at three stages of privacy levels 1 through 3.

In a case of being set at the privacy level 1, all of the movie replay log, the music replay log, and the text message are published.

In a case of being set at the privacy level 2, the movie replay log is published by being converted to the movie replay frequency log data that indicates a frequency of replaying a movie.

FIG. 8 illustrates an example of the movie replay log and the movie replay frequency log. The movie replay log is configured with combinations of a title of a movie and a date and a time of replay. The movie replay frequency log is configured with combinations of a title of a movie and a number of replay times.

Similarly, in a case of being set at the privacy level 2, the music replay log is published by being converted to the music replay log that indicates a frequency of replaying a piece of music. In the meanwhile, all text messages are published.

Accordingly, in a case of being set at the privacy level 2, in the services A and B, the past logs of a movie and a piece of music that do not have to include the information of a date and a time of replay are published while the recent logs of a movie and a piece of music that have to include the information of a date and a time of replay are not published.

In a case of being set at the privacy level 3, all of the movie replay log, the music replay log, and the text message are not published.

For example, in a case that the user 2 sets at the privacy level 1 in the case 1, the user 1, who is a friend of the user 2, is possible to browse the past log, the recent log, and the text message of the user 2 in the service B that the user 2 utilizes. In a case that the user 2 sets at the privacy level 2 in the case 1, the user 1 is possible to browse the past log and the text message of the user 2 in she service B. In a case that the user 2 sets at the privacy level 3 in the case 1, the user 1 is not possible to browse the past log, the recent log, and the text message of the user 2 in the service B.

In a case that the user 2 sets at the privacy level 1 in the case 2, although the user 2 does not utilize the service A, the user 1, who is a friend of the user 2, is possible so browse the past log, the recent log, and the text message of the user 2 in the service A. In a case that the user 2 sets at the privacy level 2 in the case 2, the user 1 is possible to browse the past log and the text message of the user 2 in the service A. In a case that the user 2 sets at the privacy level 3 in the case 2, the user 1 is not possible to browse the past log, the recent log, and the text message of the user 2 in the service A.

In a case that the user 2 sets at the privacy level 1 in the case 3, the user 3, who is not a friend of the user 2, is possible to browse the past log, the recent log, and the text message of the user 2 in the service B that the user 2 utilizes. For example, in such a case that the user 3 searches for the user 2 with a search function of the service B, the past log, the recent log, and the text message of the user 2 become displayed.

In a case that the user 2 sets at the privacy level 2 in the case 3, the user 3 is possible to browse the past log and the text message of the user 2 in the service B. For example, in such a case that the user 3 searches for the user 2 with a search function of the service B, the past log and the text message of the user 2 become displayed.

In a case that the user 2 sets at the privacy level 3 in the case 3, the user 3 is not possible to browse the past log, the recent log, and the text message of the user 2 in the service B.

In a case that the user 2 sets at the privacy level 1 in the case 4, although the user 2 does not utilize the service A, the user 3 is possible to browse the past log, the recent log, and the text message of the user 2 in the service A. For example, in such a case that the user 3 searches for the user 2 with a search function of the service A, the past log, the recent log, and the text message of the user 2 become displayed.

In a case that the user 2 sets at the privacy level 2 in the case 4, although the user 2 does not utilize the service A, the user 3 is possible to browse the past log and the text message of the user 2 in the service A. For example, in such a case that the user 3 searches for the user 2 with a search function of the service A, the past log and the text message of the user 2 become displayed.

In a case that the user 2 sets at the privacy level 3 in the case 4, the user 3 is not possible to browse the past log, the recent log, and the text message of the user 2 in the service A.

In contrast, the second privacy level can be set at three stages of privacy levels A through C regardless of the cases 1 through 4 described above.

In a case of being set at the privacy level A, the friend information (information regarding friends of the publisher) is published in a service that the publisher utilizes. For example, in a case that the user 2 sets at the privacy level A, the users 1 and 3 are possible to browse the friend, information of the user 2 in the service B that the user 2 utilizes. In the meanwhile, the users 1 and 3 are not possible to browse the friend information of the user 2 in the service A that the user 2 does not utilize.

In a case of being set at the privacy level B, the friend information is published in a service that the publisher utilizes and a service that his or her friends utilize. For example, in a case that the user 2 sets at the privacy level B, the users 1 and 3 are possible to browse the friend information of the user 2 in the service B that the user 2 utilizes. In addition, as being a friend of the user 2, the user 1 is possible to browse the friend information of the user 2 in the service A that the user 1 utilizes although the user 2 does not utilize the service A. In the meanwhile, as not being a friend of the user 2, the user 3 is not possible to browse the friend information of the user 2 in the service A that the user 2 does not utilize.

In a case of being set at the privacy level C, the friend information is published in all services. For example, in a case that the user 2 sets at the privacy level C, the users 1 and 3 are possible to browse the friend information of the user 2 in the service B that the user 2 utilizes. In addition, the users 1 and 3 are possible to browse the friend information of the user 2 in the service A although the use 2 does not utilize the service A.

As just described, each user can set a level of publishing his or her log data by setting a privacy level.

### (Log Data Providing Process)

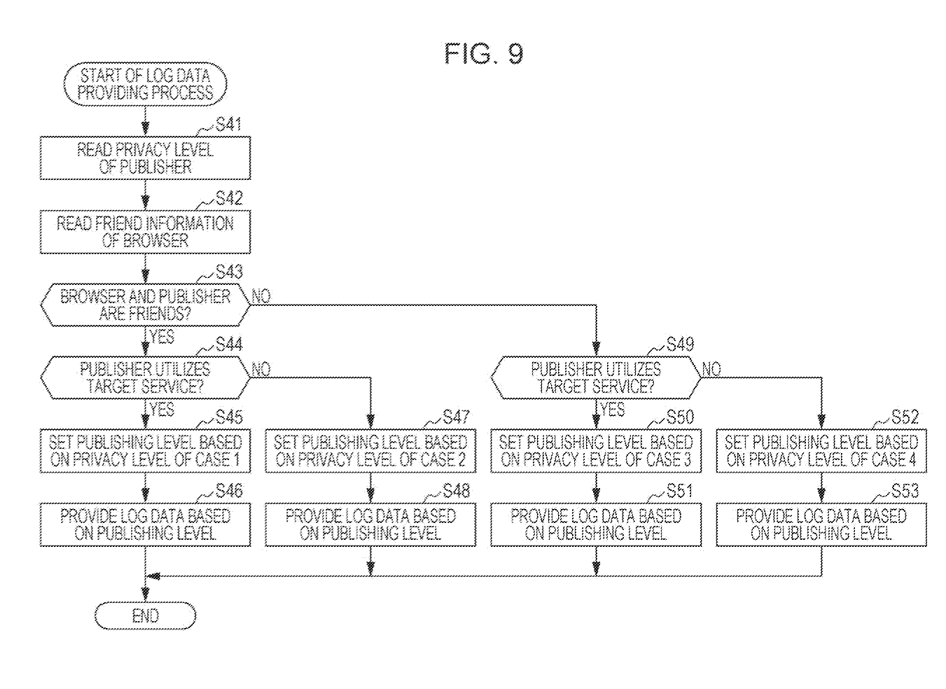

Next, with reference to the flowchart in FIG. 9, descriptions are given to log data providing process performed by the log data bank 11.

For example, in a case that a certain user (browser) operates to display log data of another user (publisher) utilizing a service that is provided by the server 12 in the client 13, a request for sending of the log data is sent to the server 12 via the network 14. Hereinafter, a service that the browser utilizes is referred to as a target service and the server 12 that provides the target service is referred to as a target server. In addition, hereinafter, the client 13 that the browser utilizes is referred to as a target client.

The target server sends a request for sending of log data of a publisher, together with information indicating a browser, a publisher, and a target service, to the log data bank 11 via the network 14. Then, when the publishing level setting section 43 in the log data bank 11 receives the information and the request above via the communication unit 31, the process in FIG. 9 starts.

In step S41, the publishing level setting section 43 reads the privacy level of the publisher from the privacy level registration information that is memorized in the memory unit 33.

In step S42, the publishing level setting section 43 reads the friend information of the browser from the user relationship information that is memorized in the memory unit 33.

In step S43, the publishing level setting section 43 determines whether or not the browser and the publisher are friends based on the friend information thus acquired. In a case of determining that the browser and the publisher are friends, the process goes on to step S44.

In step S44, the publishing level setting section 43 determines whether or not the publisher utilizes the target service. In a case of determining that the publisher utilizes the target service, the process goes on to step S45. Since the browser is a friend of the publisher and also the publisher utilizes the target service, this case falls under the case 1 in FIG. 7.

In step S45, the publishing level setting section 43 sets the publishing level based on the privacy level in the case 1. Specifically, the publishing level setting section 43 sets levels of publishing the log data of the publisher to browsers in the target service based on the privacy level that the publisher sets in the case 1. The publishing level setting section 43 notifies the providing control section 44 of the publishing level thus set.

In step S46, the providing control section 44 provides the log data based on the publishing level. Specifically, the providing control section 44 retrieves the log data of the publisher from the memory unit 33 and carries out log data processing as desired based on the publishing level that is set. Then, the providing control section 44 sends the log data to the target server via the communication unit 31 and the network 14.

The target server receives the log data and processes the log data thus received so as to allow utilization in the target service as desired. Then, the target server sends the log data to the target client, via the network 14.

The target client displays the log data thus received on a utilization screen of the target service. This presents the log data of the publisher to the browser at the publishing level based on the privacy level for the case 1.

After that, the log data providing process terminates.

On the other hand, in a case of determining that the publisher does not utilize the target service in step S44, the process goes on to step S47. Since the browser is a friend of the publisher and also the publisher does not utilize the target service, this case falls under the case 2 in FIG. 7.

In step S47, the publishing level setting section 43 sets the publishing level based on the privacy level in the case 2. Specifically, the publishing level setting section 43 sets the level of publishing the log data of the publisher cc the browser in the target service based on the privacy level that the publisher sets in the case 2. The publishing level setting section 43 notifies the providing control section 44 of the publishing level thus set.

In step S48, by process similar to step S46, log data based on the publishing level is provided. This presents the log data of the publisher to the browser at the publishing level based on the privacy level in the case 2.

After that, the log data providing process terminates.

On the other hand, in a case of determining that the browser and the publisher are not friends in step S43, the process goes on to step S49.

In step S49, similar to the process in step S44, whether or not the publisher utilizes the target service is determined. In a case of determining that the publisher utilizes the target service, the process goes on to step S50. Since the browser is not a friend of the publisher and also the publisher utilizes the target service, this case falls under the case 3 in FIG. 7.

In step S50, the publishing level setting section 43 sets the publishing level based on the privacy level in the case 3. Specifically, the publishing level setting section 43 sets the level of publishing the log data of the publisher to the browser in the target service based on the privacy level that the publisher sets in the case 3. The publishing level setting section 43 notifies the providing control section 44 of the publishing level thus set.

In step S51, by process similar to step S46, the log data based on the publishing level is provided. This presents the log data of the publisher to the browser at the publishing level based on the privacy level in the case 3.

After that, the log data providing process terminates.

In the meanwhile, in a case of determining that the publisher does not utilize the target service in step S49, the process goes on to step S52. Since the browser is not a friend of the publisher and also the publisher does not utilize the target service, this case falls under the case 4 in FIG. 7.

In step S52, the publishing level setting section 43 sets the publishing level based on the privacy level in the case 4. Specifically, the publishing level setting section 43 sets the level of publishing the log data of the publisher to the browser in the target service based on the privacy level that the publisher sets in the case 4. The publishing level setting section 43 notifies the providing control section 44 of the publishing level thus set.

In step S53, by process similar to step S46, the log data based on the publishing level is provided. This presents the log data of the publisher to the browser at the publishing level based or the privacy level in the case 4.

After that, the log data providing process terminates.

### (Specific Example of Log Data Providing Process)

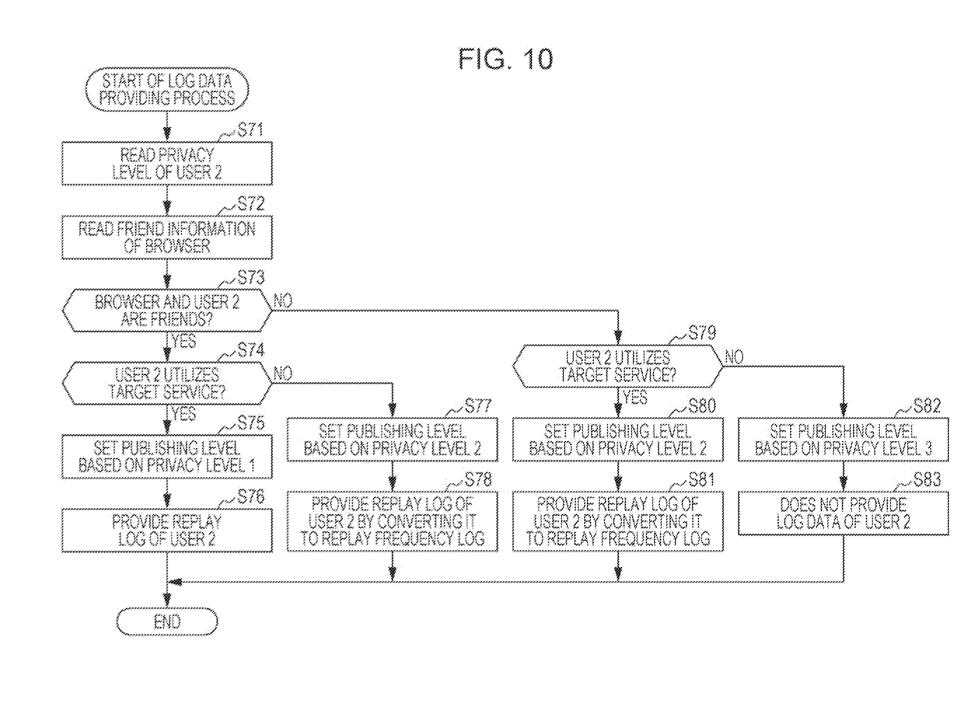

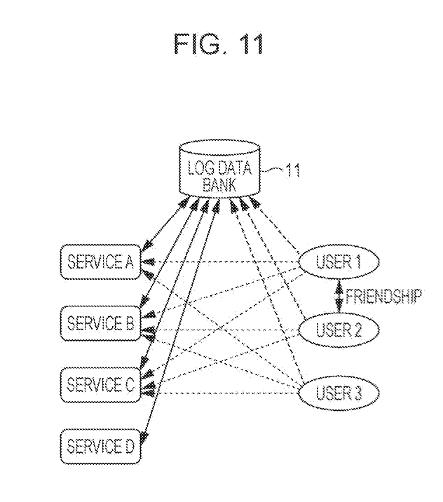

Next, with reference to the flowchart in FIG. 10, descriptions are given to a specific example of the log data providing process described above referring to FIG. 9.

An example of a case that the user 1 or 3 browses the movie replay log or the music replay log of the user 2 in the service A or B is described below. It is assumed below that the privacy level of the user 2 is set at the privacy level 1 in the case 1, set at the privacy level 2 in the cases 2 and 3, and set at the privacy level 3 in the case 4.

In step S71, the publishing level setting section 43 reads the privacy level of the user 2, who is the publisher, from the privacy level registration information memorized in the memory unit 33.

In step S72, the publishing level setting section 43 reads the friend information of the browser from the user relationship information memorized in the memory unit 33.

In step S73, the publishing level setting section 43 determines whether or not the browser and the user 2 are friends. In a case that the browser is the user 1, the browser and the user 2 are determined as friends, and the process goes on to step S71.

In step S74, the publishing level setting section 43 determines whether or not the user 2 utilizes a target service. In a case that the target service is the service B, it is determined that the user 2 utilizes the target service and the process goes on to step S75. This is a case of the case 1.

In step S75, the publishing level setting section 43 sets the publishing level based on the privacy level 1. That is, the publishing level setting section 43 sets the publishing level so as to publish all music replay log of the user 2 to the user 1, who is the browser, in the service B, which is the target service. The publishing level setting section 43 notifies the providing control section 44 of the publishing level thus set.

In step S76, the providing control section 44 provides a replay log of the user 2. Specifically, the providing control section 44 reads the music replay log of the user 2 from the memory unit 33. Then, the providing control section 44 sends the music replay log of the user 2 to the server 12 that provides the service B via the communication unit 31 and the network 14.

The server 12 that has received the music replay log sends the music replay log thus received to the client 13 of the user 1 via the network 14.

The client 13 that has received, the music replay log displays the past and recent music replay logs of the user 2 on the utilization screen of the service B. This enables the user 1 to browse the past and recent music replay logs of the user 2 in the service B.

After that, the log data providing process terminates.

In the meanwhile, in a case that the target service is the service A in step S74, it is determined that the user 2 does not utilize the target service and the process goes on to step S77. This is a case of the case 2.

In step S77, the publishing level setting section 43 sets the publishing level based on the privacy level 2. That is, the publishing level, setting section 43 sets the publishing level so as to publish the movie replay log of the user 2 to the user 1, who is a browser, by converting it to the movie replay frequency log in the service A, which is the target service. The publishing level setting section 43 notifies the providing control section 44 of the publishing level thus set.

In step S78, the providing control section 44 provides the replay log of the user 2 by converting it to a replay frequency log. Specifically, the providing control section 44 reads the movie replay log of the user 2 from the memory unit 33 and converts it to a movie replay frequency log. Then, the providing control section 44 sends the movie replay frequency log of the user 2 to the server 12 that provides the service A via the communication unit 31 and the network 14.

The server 12 that has received the movie replay frequency log sends the movie replay frequency log thus received to the client 13 of the user 1 via the network 14.

The client 13 that has received the movie replay frequency log displays the past movie replay log of the user 2 on a utilization screen of the service A. This enables the user 1 to browse the past movie replay log of the user 2 in the service A.

After that, the log data providing process terminates.

In the meanwhile, in a case that the browser is the user 3 in step S73, it is determined that the browser and the user 2 are not friends and the process goes on to step S79.

In step S79, similar to the process in step S74, whether or not the user 2 utilizes the target service is determined. In a case that the target service is the service B, it is determined that the user 2 utilizes the target service and the process goes on to step S80. This is a case of the case 3.

In step S80, the publishing level setting section 43 sets the publishing level based on the privacy level 2. That is, the publishing level setting section 43 sets the publishing level so as to publish the music replay log of the user 2 by converting it to a music replay frequency log to the user 3, who is the browser, in the service B, which is the target service. The publishing level setting section 43 notifies the providing control section 44 of the publishing level thus set.

In step S81, the providing control section 44 provides the replay log of the user 2 by converting it to the replay frequency log. Specifically, the providing control section 44 reads the music replay log of the user 2 from the memory unit 33 and converts it to a music replay frequency log. Then, the providing control section 44 sends the music replay frequency log of the user 2 to the server 12 that provides the service B via the communication unit 31 and the network 14.

The server 12 that has received the music replay frequency log sends the music replay frequency log thus received to the client 13 of the user 3 via the network 14.

The client 13 that has received the music replay frequency log displays a past music replay log of the user 2 on a utilization screen of the service B. This enables the user 3 to browse the past music replay log of the user 2 in the service B.

After that, the log data providing process terminates.

In the meanwhile, in a case that the target service is the service A in step S79, it is determined that the user 2 does not utilize the target service and the process goes on to step S82. This is a case of the case 4.

In step S82, the publishing level seining section 43 sets the publishing level based on the privacy level 3. That is, the publishing level setting section 43 sets the publishing level so as not to publish the movie replay log of the user 2 to the user 3, who is the browser, in the service A, which is the target service. The publishing level setting section 43 notifies the providing control section 44 of the publishing level thus set.

In step S83, the providing control section 44 does not provide the log data of the user 2. Accordingly, the user 3 is not possible to browse the past and recent movie replay logs of the user 2 in the service A.

After that, the log data providing process terminates.

As just described, it is possible to share the log data in each service among a plurality of services. This brings benefits, as described above with reference to FIG. 1, to both the service providing companies that provide the services and the users that utilize the services. For example, the service providing companies become possible to provide more excellent services using a variety of log data while, for the users, the convenience in utilizing a plurality of services is improved.

In addition, each user can restrict the range and the mode of publishing the log data in accordance with the browsers and the services at publishing destinations by setting the privacy level. More specifically, each user can restrict the range and the mode of publishing the log data in accordance with whether or not the browser is a friend of him or her and whether or not the service at a publishing destination is a service that he or she utilizes. As a result, it is possible to reduce a risk, such as leakage of privacy information for sharing log data among a plurality of services.

### 3. Modifications

Descriptions are given below to modifications of the embodiment, of the present technology described above.

### [Modification 1: Modification of Privacy Level and Publishing Level]

The contents of privacy level settings described above are an example thereof and are not limited to the example described above. For example, it is possible to modify the contents of the first privacy level settings as follows.

Privacy level 1′: To publish all log data.
Privacy level 2′: To publish log data by converting it to frequency information of movie and music.
Privacy level 3′: To publish log data by selecting a part of it randomly.
Privacy level 4′: To publish log data by converting it to information whether or not a movie or a piece of music is replayed.

Privacy level 5′: To publish log data as a series of a group to which a movie or a piece of music belongs.

In addition, a period to publish the log data may also be set by the privacy level. For example, the period to publish the log data may also be restricted to the last one week, one month, one year, and the like.

Further, the privacy level may also be set for each type of log data. This enables to differentiate the publishing levels of, for example, the movie replay log and the music replay log. In addition, for example, since the mode of publishing is different according to the nature of log data, it becomes possible to set a publishing level in accordance with each mode of publishing of log data. For example, it becomes possible to differentiate the publishing levels of a log of replaying a content and a log of purchasing goods, which are different in nature.

In addition, a privacy level may also be set for each service at a publishing destination. This enables to differentiate, for example, publishing levels for the service A and the service B regardless of whether or not the publisher utilizes.

Further, in a case of allowing a privacy level to be set for each service, the privacy level may also be set by being divided into the cases 1 through 4 for each service. It is to be noted that, in this case, determination of the service defines whether or not oneself (publisher) utilizes, so that it is also possible to set a privacy level for each service by dividing into only two cases of whether or not the browsing is by a user registered as a friend.

In addition, restrictive conditions may also be given for setting of privacy levels to be consistent among each case. For example, it is considered to give restrictive conditions as follows.

Privacy level of case 1≦Privacy level of case 2

Privacy level of case 1≦Privacy level of case 3

Privacy level of case 2≦Privacy level of case 4

Privacy level of case 3≦Privacy level of case 4

For example, the case 1 is a case of publishing log data to a friend and the case 3 is a case of publishing log data to a user other than a friend, so that as shown in the second formula, the privacy level of the case 1 is set not more than the privacy level of the case 3. In other words, the range of publishing the log data in the case 1 is set same as or wider than the range of publishing the log data in the case 3.

Further, in order to meet the above restrictive conditions, based on the privacy level that has already set by a user, privacy levels of other unset cases may also be set automatically to assist user settings. In addition, for example, in order to meet the above restrictive conditions, the privacy level for each case that has already set may also be corrected.

Still in addition, although in the example of FIG. 7, an example of classifying the cases by considering only friendship as a type of relationship between the publisher and the browser, the classification may also be made using a type of relationship among users other than friendship. For example, in a case that two users are linked in one direction to be in relationship of so-called a follower and a followee, a case that is different from friendship may also be provided. Yet in addition, for example, friendship may also be classified into a plurality of levels to classify cases for each level. This enables to set a publishing level more precisely using the relationship between the publisher and the browser.

Further, for example, the cases may also be classified based on, in FIG. 7, only one of whether or not oneself (publisher) utilizes the service or whether or not a user registered as a friend browses.

In addition, although in the above description, an example of publishing a replay log by converting it to a replay frequency log is shown as an example of modifying a mode of publishing log data using a publishing level, it is not limited to this example. For example, it is considered to make contents of log data broader in concept for publishing and to convert a display format (for example, schematization, digitization, and the like) for publishing.

The embodiment and the modifications of the privacy levels and publishing levels described above can be used by combining with each other and also singly.

### [Modification 2: Modification of Service]

The types of service that utilizes the log sharing service are not limited to the examples described above and are not limited in particular as long as they are network services that are provided via a network, such as the internet. In addition, for example, even a service that is not provided directly to a user can utilize the log sharing service.

FIG. 11 illustrates an example of further adding a service D to the specific example in FIG. 4. The service D is a service to, for example, take statistics on a situation of listening to a piece of music (such as weekly listening ranking) for publishing and is not a service that is directly provided to users. Even a service that is not directly provided to users, such as the service D, can utilize the log sharing service.

Since the user does not utilize the service D, it is not appropriate to set the privacy level by dividing it into the cases illustrated in FIG. 7. Accordingly, it is desired that each user can set a privacy level for the service D separate from the services A through C.

For example, it is considered to allow each user to set the privacy level 1 or 3 for the service D without distinguishing the cases 1 through 4, separate from the services A through. C. For example, it is possible to publish log data of the user set at the privacy level 1 from the log data bank 11 to the service D and not to publish log data of the user set at the privacy level 3 from the log data bank 11 to the service D.

In addition, for example, a privacy level may also be set separate from the cases 1 through 4 by adding a case of publishing log data to a service that a user does not utilize as a case 5 other than the cases 1 through 4.

### [Modification 3: Modification of Log Data Format]

The log data format shown in FIG. 8 is one example thereof and it is possible to employ an optional format in an embodiment of the present technology. For example, other than the symbolic time series log data as illustrated in FIG. 8, it is also possible to employ real vector time series log data. The real vector time series log data is, for example, time series log data of location information and is data expressed in a format, such as (34.5, 135.4, 2012/7/25 10:00), (34.4, 135.2, 2012/7/25 10:05), . . . . Such data is expressed by combinations of (latitude, longitude, date and time).

### [Modification 4: Other Modifications]

Although the descriptions above show examples in which the log data bank 11 collects friend information in each service to summarize friendship among users into one, each user may also register friendship directly in the log sharing service.

In addition, although the descriptions above show examples in which the setting information for the privacy level is sent from the client 13 to the log data bank 11, that is, each user sets a privacy level to the log data bank 11, each user may also set a privacy level utilizing each service that is provided by the server 12, for example. In this case, the setting information for the privacy level is sent from each client 13 through each server 12 to the log data bank 11, for example.

### [Configuration Example of Computer]

The series of processing described above is possible to be performed by hardware and also by software. In a case of performing the series of process by software, a program configuring the software is installed to a computer. Here, this computer includes a computer built in exclusive use hardware and general purpose personal computers, for example, that are possible to perform various functions by installing various programs thereto.

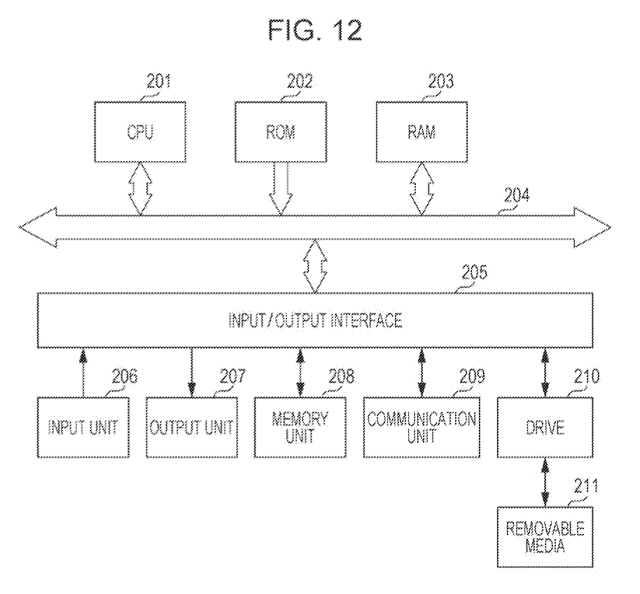

FIG. 12 is a block diagram illustrating a hardware configuration example of a computer that performs the series of processing described above using a program.

In the computer, a central processing unit (CPU) 201, a read only memory (ROM) 202, and a random access memory (RAM) 203 are connected with each other by bus 204.

The bus 204 is connected further with an input/output interface 205. The input/output interface 205 is connected with an input unit 206, an output unit 207, a memory unit 208, a communication unit 209, and a drive 210.

The input unit 206 includes a keyboard, a mouse, a microphone, and the like. The output unit 207 includes a display, a speaker, and the like. The memory unit 208 includes a hard disk, a nonvolatile memory, and the like. The communication unit 209 includes a network interface and the like. The drive 210 drives a removable media 211, such as a magnetic disk, an optical, disk, a magneto optical disk, and a semiconductor memory.

In a computer configured as above, the CPU 201 loads a program that is memorized in the memory unit 208, for example, in the RAM 203 via the input/output interface 205 and the bus 204 to be performed, thereby carrying out the series of processing described above.

The program performed by the computer (CPU 201) can be provided by, for example, recording it in the removable media 211 as a packaged media or the like. The program can also be provided via a wired or wireless transmission medium, such as a local area network, the internet, and digital satellite broadcasting.

In the computer, the program can be installed to the memory unit 208 via the input/output interface 205 by mounting the removable media 211 to the drive 210. The program can also be received at the communication unit 209 via a wired or wireless transmission medium and installed to the memory unit 208. Other than that, the program can be installed in advance to the ROM 202 or the memory unit 208.

The program performed by the computer may be a program that processes in time series in the order described herein and may also be a program processes in parallel or at a desired timing, such as on-call.

The system herein designates an assembly of a plurality of components (devices, modules (parts), and the like) and it does not matter whether or not all components are in an identical housing. Accordingly, both a plurality of devices that are stored in separate housings and connected via a network and one device having a plurality of modules stored in one housing are systems.

Further, embodiments of the present technology are not limited to the embodiment described above and various modifications can be made thereto without departing from the spirit of the present technology.

For example, an embodiment of the present technology can be configured as cloud computing in which one function is processed by being divided among a plurality of devices via a network in cooperation.

In addition, each step described in the flowcharts described above can be performed by being divided, other than performed with one device, among a plurality of devices.

Further, in a case that a plurality of processing are included in one step, the plurality of processing included in that one step can be performed by being divided, other than performed with one device, among a plurality of devices.

Still in addition, for example, embodiments of the present technology can also be configured as below.

(1)

An information processing device including:

a collection section that collects log data of a plurality of users from a plurality of services;

a publishing level setting section that is possible to set a publishing level of the collected log data to each service for each user; and

a providing control section that controls provision of the collected log data to the plurality of services based on the publishing level that is set.

(2)

The information processing device according to (1) above, wherein

the publishing level setting section is possible to further set the publishing level for each service at a publishing destination.

(3)

The information processing device according to (1) or (2) above, wherein.

the publishing level setting section is possible to further set the publishing level based on relationship between a user to publish the log data and a user to browse it.

(4)

The information processing device according to any one of (1) through (3) above, wherein

the publishing level setting section is possible to further set the publishing level, based on whether or not the service at a publishing destination is a service that a user to publish the log data utilizes.

(5)

The information processing device according to any one of (1) through (4) above, wherein

the publishing level setting section is possible to further set the publishing level for each type of log data.

(6)

The information processing device according to (1) above, wherein

the publishing level setting section is possible to further set the publishing level based on one or more combinations of the service at a publishing destination, relationship between a user to publish the log data and a user to browse it, whether or not the service at a publishing destination is a service that the user to publish the log data utilizes, and a type of log data.

(7)

The information processing device according to any one of (1) through (6) above, wherein

the providing control section controls a range and a mode of providing the collected log data to each service based on the publishing level.

(8)

An information processing method carried out by an information processing device, the method including:

collecting log data of a plurality of users from a plurality of services;

publishing level setting possible to set a publishing level of the collected log data to each service for each user; and

controlling provision of the collected log data to the plurality of services based on the publishing level that is set.

(9)

An information processing system including:

a first server, a plurality of second servers that provide a predetermined service, and a plurality of clients that utilize the service that is provided by the second servers; wherein

the first server has
a collection section that collects log data of a plurality of users from a plurality of services,
a publishing level setting section that is possible to set a publishing level of the collected log data to each service for each user, and
a providing control section that controls provision of the collected log data to the plurality of services based on the publishing level that is set.

The present disclosure contains subject matter related to that disclosed in Japanese Priority Patent Application JP 2012-169499 filed in the Japan Patent Office on Jul. 31, 2012, the entire contents of which are hereby incorporated by reference.

What is claimed is:

1. An information processing device comprising:
a collection section that collects log data of a plurality of users from a plurality of services;
a publishing level setting section that is possible to set a publishing level of the collected log data to each service for each user; and
a providing control section that controls provision of the collected log data to the plurality of services based on the publishing level that is set.

2. The information processing device according to claim 1, wherein
the publishing level setting section is possible to further set the publishing level for each service at a publishing destination.

3. The information processing device according to claim 1, wherein
the publishing level setting section is possible to further set the publishing level based on relationship between a user to publish the log data and a user to browse it.

4. The information processing device according to claim 1, wherein
the publishing level setting section is possible to further set the publishing level based on whether or not the service at a publishing destination is a service that a user to publish the log data utilizes.

5. The information processing device according to claim 1, wherein
the publishing level setting section is possible to further set the publishing level for each type of log data.

6. The information processing device according to claim 1, wherein
the publishing level setting section is possible to further set the publishing level based on one or more combinations of the service at a publishing destination, relationship between a user to publish the log data and a user to browse it, whether or not the service at a publishing destination is a service that the user to publish the log data utilizes, and a type of log data.

7. The information processing device according to claim 1, wherein
the providing control section controls a range and a mode of providing the collected log data to each service based on the publishing level.

8. An information processing method carried out by an information processing device, the method comprising:
collecting log data of a plurality of users from a plurality of services;
publishing level setting possible to set a publishing level of the collected log data to each service for each user; and
controlling provision of the collected log data to the plurality of services based on the publishing level that is set.

9. An information processing system comprising
a first server;
a plurality of second servers that provide a predetermined service; and
a plurality of clients that utilize the service that is provided by the second servers; wherein
the first server includes
a collection section that collects log data of a plurality of users from a plurality of services,
a publishing level setting section that is possible to set a publishing level of the collected log data to each service for each user, and
a providing control section that controls provision of the collected log data to the plurality of services based on the publishing level that is set.
